(19) United States
(12) Patent Application Publication
(10) Pub. No.: US 2020/0248814 A1
(43) Pub. Date: Aug. 6, 2020

(54) SEAL ASSEMBLY WITH SPRING RETAINER RUNNER MOUNT ASSEMBLY

(71) Applicant: Rolls-Royce Corporation, Indianapolis, IN (US)

(72) Inventors: Mark Schubert, Indianapolis, IN (US); James Bernacchi, Indianapolis, IN (US); Joseph Black, Brownsburg, IN (US)

(73) Assignee: Rolls-Royce Corporation, Indianapolis, IN (US)

(21) Appl. No.: 16/265,506

(22) Filed: Feb. 1, 2019

(51) Int. Cl. F16J 15/34

(52) U.S. Cl. CPC F16J 15/3464

(57) ABSTRACT

A seal assembly is disclosed for sealing a higher pressure fluid cavity from a lower pressure fluid cavity. The seal assembly comprises a runner mounting assembly, a circumferential ceramic runner carried by the runner mount assembly, and a carbon seal ring sealingly engaged to the runner. The runner mount assembly comprises a pair of axial retainers each having a base portion and a retaining portion, and a mounting member positioned axially intermediate the axial retainers. The mounting member comprises a circumferential base and a pair of spring retainers extending axially and radially from the base. The runner is axially positioned between the retaining portions of the axial retainers and radially positioned between the spring retainers and the carbon seal ring.

### CROSS-REFERENCE TO RELATED APPLICATIONS

This application is related to concurrently filed and co-pending application U.S. patent application Ser. No. ______ entitled “Mounting Assembly for a Ceramic Seal Runner,” the entirety of which is herein incorporated by reference.

### BACKGROUND

Seals and seal assemblies may be used to isolate cavities of different pressures in a machine. For example, in a gas turbine engine a seal assembly may be used to seal a sump from higher pressure and temperature airflows elsewhere in the engine, such that oil is retained in the sump and not permitted to migrate to other regions of the engine. Oil leakage from a sump can lead to undesirable conditions such as fires, smoke, coking, and migration of oil smell.

A seal assembly typically comprises a seal ring engaged with a runner. The runner is often carried by a runner mount that is coupled to a rotatable shaft. Engagement between the seal ring and runner creates the seal.

Some existing runner mounts hold the runner in place by contacting both a radially inner and a radially outer surface of the runner. These runner mount designs can lead to excessive stresses in the runner and/or the runner mount due to edge loading along the runner/runner mount interface at the radially outer surface of the runner. These runner mount designs also require that a portion of the radially outer surface of the runner—i.e. the surface that forms a seal through engagement with the seal ring—be dedicated to mounting as opposed to sealing. Improvements in runner mount designs are therefore desirable.

### SUMMARY

According to some aspects of the present disclosure, a seal assembly is disclosed for sealing a higher pressure fluid cavity from a lower pressure fluid cavity. The cavities are at least partially disposed between a rotatable shaft and a housing radially displaced from the rotatable shaft. The seal assembly comprises a runner mounting assembly, a carbon seal ring, and a circumferential ceramic runner.

The runner mounting assembly is carried by the shaft and comprises a first axial retainer, a second axial retainer, and a mounting member. The first axial retainer is affixed to the shaft and comprises a circumferential base portion and a retaining portion extending radially outward from the base portion. The second axial retainer is affixed to the shaft at a position axially displaced from the first axial retainer. The second axial retainer comprises a circumferential base portion and a retaining portion extending radially outward from the base portion. The mounting member is positioned axially intermediate the first and second axial retainers. The mounting member comprises a circumferential base affixed to the shaft and a pair of spring retainers extending axially and radially from the base.

The carbon seal ring is sealingly engaged with the housing and has a radially inward facing seal surface. The circumferential ceramic runner has a radially outward facing seal surface and a radially inward facing mount surface. The runner is axially positioned between the retaining portions of the first and second axial retainers and is radially positioned between the spring retainers and the carbon seal ring so that the radially inward facing seal surface of the carbon seal ring sealingly engages the radially outward facing seal surface of the runner to thereby form a boundary between the higher pressure fluid cavity and the lower pressure fluid cavity.

In some embodiments the pair of spring retainers deflect to maintain engagement of the runner and seal ring while accommodating thermal expansion of the shaft. In some embodiments the pair of spring retainers impart spring action to maintain engagement of the runner and seal ring while accommodating thermal contraction of the shaft. In some embodiments the radially outward facing seal surface of the runner is free of loading from the runner mounting assembly.

In some embodiments one of the pair of spring retainers comprises an axial locator, and wherein the ceramic runner comprises a locator groove that interfaces with the axial locator to maintain an axial position of the ceramic runner relative to the runner mounting assembly. In some embodiments the pair of spring retainers comprises a first spring retainer extending axially forward and radially outward from the base and a second spring retainer extending axially aft and radially outward from the base. In some embodiments the runner mounting assembly comprises metal.

In some embodiments the seal assembly further comprises an annular seal member coupled to the housing axially displaced from the seal ring in the lower pressure fluid cavity, the seal member having a curvilinear face surface that engages the radially outward facing seal surface of the runner. In some embodiments the higher pressure fluid cavity comprises at least in part a buffer air chamber, and wherein a plurality of apertures extending axially through the seal ring direct a flow of buffer air from the buffer air chamber toward the annular seal member. In some embodiments the curvilinear face surface bends from an axially-facing surface to a radially-facing surface, and wherein the radially-facing surface engages the radially outward facing seal surface of the runner.

In some embodiments the runner and the seal ring are formed from materials having coefficients of thermal expansion that are matched to effect sealing engagement between the runner and the seal ring over a predetermined range of operating temperatures. In some embodiments the seal assembly further comprises a garter spring coupled to a radially outward facing surface of the seal ring, the garter spring sealingly engaging the radially inward facing seal surface of the seal ring with the radially outward facing seal surface of the ceramic runner across a predetermined range of rotational speeds.

According to further aspects of the present disclosure, a seal assembly is disclosed for sealing a first fluid cavity from a second fluid cavity in a rotating machine. The cavities are at least partially disposed between a rotatable shaft and a housing radially displaced from the rotatable shaft. The seal assembly comprises a circumferential ceramic runner, a runner mounting assembly, and a carbon seal ring. The circumferential ceramic runner has a radially outward facing seal surface and a radially inward facing mount surface extending axially along the shaft. The runner mounting assembly is carried by the shaft and carries the ceramic runner.

The runner mounting assembly comprises a base member and a pair of metallic spring retainers. The base member is positioned at a radial offset from the ceramic runner. The pair of metallic spring retainers include a first spring retainer extending axially forward from the base member and a second spring retainer extending axially aft from the base member. The spring retainers extend across the radial offset and engage a portion of the radially inward facing mount surface of the runner.

The carbon seal ring is sealingly engaged with the housing and has a radially inward facing seal surface that sealingly engages at least a portion of the radially outward facing seal surface of the runner.

In some embodiments the pair of spring retainers deflect to maintain engagement of the runner and seal ring while accommodating thermal expansion of the shaft. In some embodiments the pair of spring retainers impart spring action to maintain engagement of the runner and seal ring while accommodating thermal contraction of the shaft. In some embodiments one of the pair of spring retainers comprises an axial locator, and wherein the ceramic runner comprises a locator groove that interfaces with the axial locator to maintain an axial position of the ceramic runner relative to the runner mounting assembly.

According to yet further aspects of the present disclosure, a method is provided of sealing a higher pressure fluid cavity from a lower pressure fluid cavity. The cavities are at least partially disposed between a rotatable shaft and a housing radially displaced from the rotatable shaft. The method comprises providing a runner mounting assembly, a circumferential ceramic runner, and a carbon seal ring, wherein the runner mounting assembly is carried by the shaft and carries the ceramic runner, the runner mounting assembly comprising a pair of spring retainers extending axially and radially from a base member to engage a portion of the runner; engaging the runner with the carbon seal ring; rotating the shaft; and deflecting the pair of spring retainers responsive to thermal transients to alter the radial position of the runner relative to the shaft.

In some embodiment the method further comprises imparting spring action from the spring retainers responsive to thermal transients to alter the radial position of the runner relative to the shaft. In some embodiment the method further comprises preventing excessive axial motion of the ceramic runner with one or more axial retainers. In some embodiment the method further comprises providing an annular seal member axially displaced from the carbon seal ring, the carbon seal ring defining a plurality of apertures passing axially through the seal ring; directing a flow of buffer air through one or more of the plurality of apertures and toward the annular seal member; and buffering the annular seal member with the flow of buffer air.

### BRIEF DESCRIPTION OF THE DRAWINGS

The following will be apparent from elements of the figures, which are provided for illustrative purposes.

FIG. 1 is a schematic cross sectional view of a seal assembly in accordance with some embodiments of the present disclosure.

FIG. 2 is a detailed schematic cross sectional view of a runner and runner mount of a seal assembly in accordance with some embodiments of the present disclosure.

FIG. 3 is a flow diagram of a method in accordance with some embodiments of the present disclosure.

FIG. 4 is an isometric view of a mounting member in accordance with some embodiments of the present disclosure.

FIG. 5 is an isometric view of a first axial retainer in accordance with some embodiments of the present disclosure.

FIG. 6 is an isometric view of a second axial retainer in accordance with some embodiments of the present disclosure.

FIG. 7 is an isometric view of a ceramic runner in accordance with some embodiments of the present disclosure.

FIG. 8 is an isometric view of a mounting member coupled to a base mount in accordance with some embodiments of the present disclosure.

The present application discloses illustrative (i.e., example) embodiments. The claimed inventions are not limited to the illustrative embodiments. Therefore, many implementations of the claims will be different than the illustrative embodiments. Various modifications can be made to the claimed inventions without departing from the spirit and scope of the disclosure. The claims are intended to cover implementations with such modifications.

### DETAILED DESCRIPTION

For the purposes of promoting an understanding of the principles of the disclosure, reference will now be made to a number of illustrative embodiments in the drawings and specific language will be used to describe the same.

Seal assemblies in rotating machines such as gas turbine engines that use a circumferential carbon seal ring and ceramic runner offer numerous advantages over existing seal assemblies that typically use a metal runner. Clearance between the carbon seal ring and ceramic runner can be more closely controlled because the materials of the seal ring and runner have closer and/or matched coefficients of thermal expansion. Closer clearance control over the full range of operating conditions ensures less leakage and less risk of oil passing through the seal assembly. Further, the use of a ceramic runner may allow for the reduction or elimination of direct oil cooling to the runner, as the ceramic runner is able to operate at higher temperatures. Reduction or elimination of direct oil cooling carries additional benefits, namely reducing the size and complexity of oil cooling systems.

However, a seal mount is required for this type of seal assembly in order to mount the ceramic runner to the metal rotatable shaft and compensate for the differential thermal growth between the runner and the shaft. The seal mount must provide adequate compliance between the shaft and the ceramic to accommodate any unacceptable stresses, excursions, and/or deflections.

Runners made from ceramic tend to have relatively high compressive yield stress but relatively low tensile yield stress. Ceramic runners also tend to be brittle, with a small elastic region. With these material difficulties in mind, ceramic runners must be coupled in some manner to the metal rotatable shaft of the engine. The assembly for mounting the runner to the shaft necessarily must account for differences in the coefficient of thermal expansion between the ceramic runner and the metal shaft, and must also accommodate excursions in the relative positioning between the two. Existing ceramic runner mounts may use a “clip” approach that includes runner/runner mount interfaces along both the radially inner and radially outer surfaces of the runner. These interfaces ensure that the runner mount is able to hold the runner against the seal ring to maintain an effective seal, while also allowing some degree of flexing between the runner and the rotatable shaft.

Unfortunately, the clip approach to runner mount design can negatively impact the effective lifespan of the runner and/or the runner mount. The runner/runner mount interface along the radially outer surface of the runner may experience excessive stresses (i.e. edge loading) during operation, leading to wear of one or more components at an unacceptable rate. For example, excessive wear may occur at the interface between the clip and the ceramic runner. Further, the clip approach reduces the size of the radially outer surface of the runner available for sealing because some portion of that surface is used for mounting purposes.

To prevent excessive edge loading at the runner/runner mount interface along the radially outer surface of the runner and to free a portion of that radially outer surface, the present disclosure is directed to systems and methods of forming a seal in a rotating machine. A seal assembly may comprise a runner mounting assembly, a runner, and a seal ring. The runner mounting assembly may engage the runner along the radially inner surface of the runner, and not along the radially outer surface of the runner. The runner mounting assembly may comprise a mounting member having a pair of spring retainers extending axially and radially from a base. The runner mounting assembly may further comprise one or more axial retainers. The seal assembly may further comprise a buffered annular sealing member or lip seal.

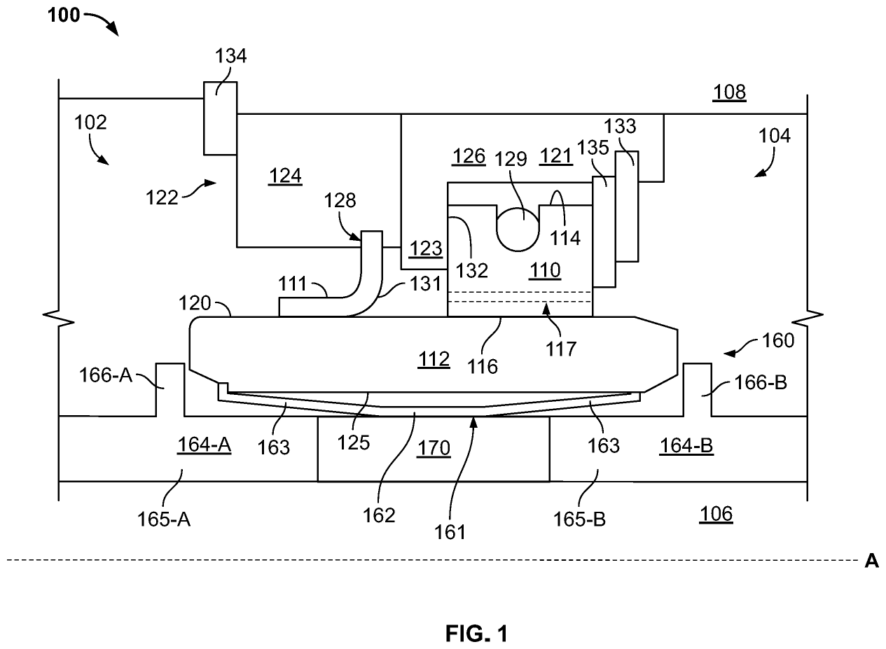

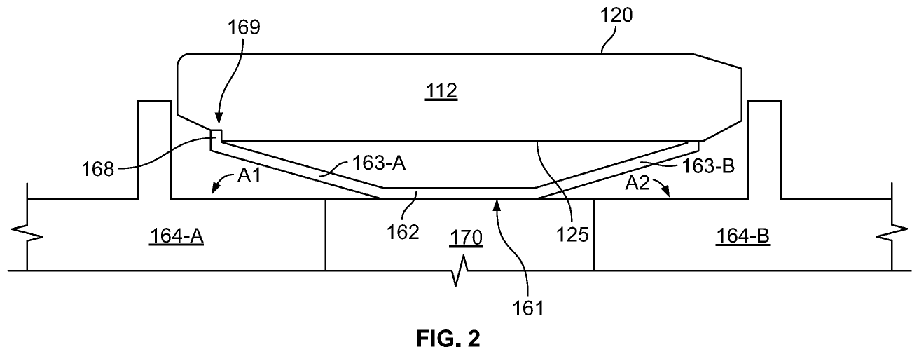

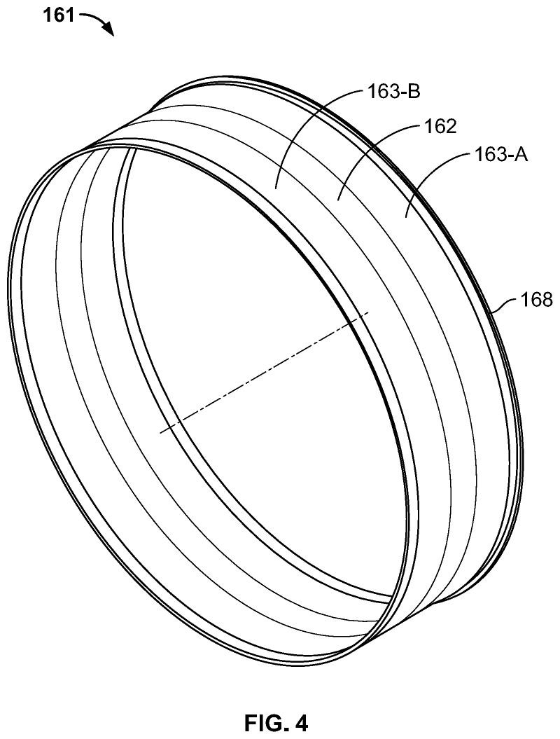

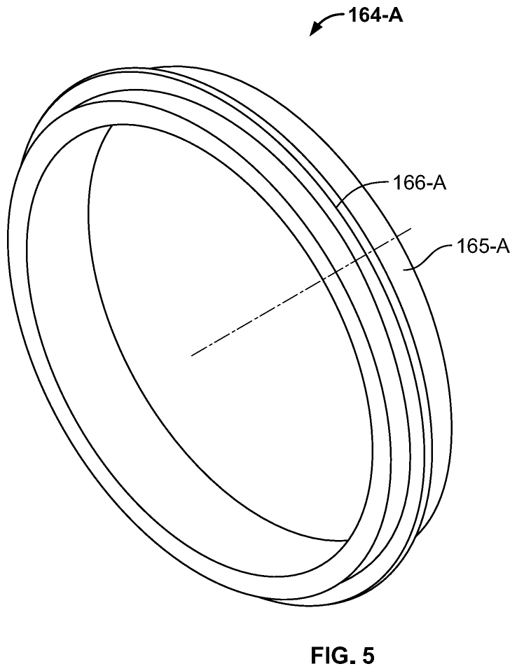

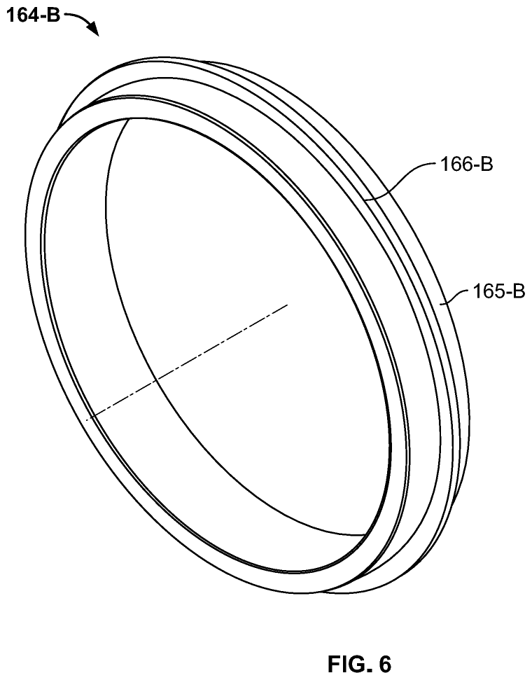

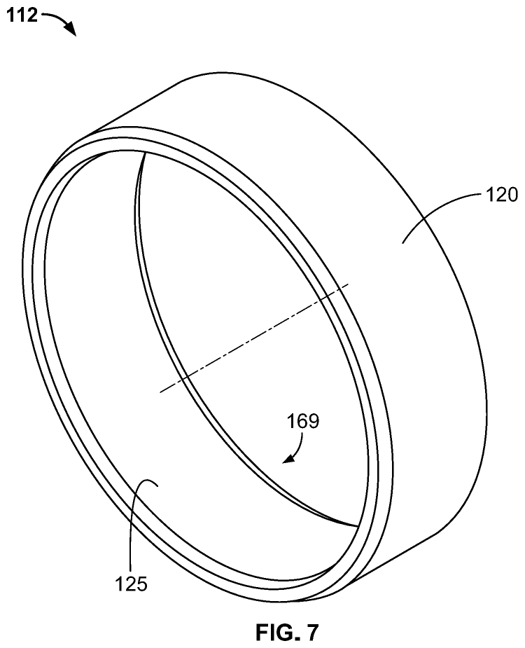

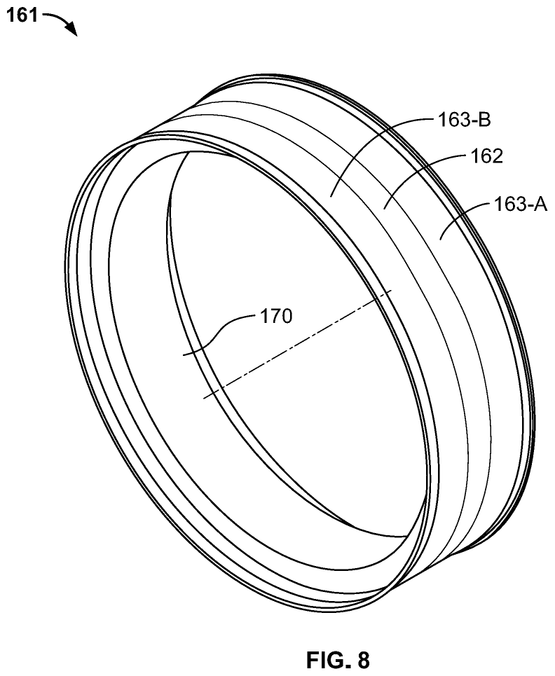

A schematic cross sectional view of an embodiment of the seal assembly 100 is provided in FIGS. 1 and 2. FIGS. 4 through 8 provide isometric views of certain components of the seal assembly 100.

The seal assembly 100 seals a higher pressure fluid cavity 104 from a lower pressure fluid cavity 102. The higher and lower pressure fluid cavities 104, 102 may be at least partially disposed between a rotatable shaft 106 and a housing 108. The seal assembly 100 comprises a seal ring 110, a circumferential runner 112, and a runner mounting assembly 160.

The higher pressure fluid cavity 104 may be referred to as a first cavity, and may be, for example, a region of a rotating machine such as a gas turbine engine that receives and directs higher pressure and/or higher temperature airflow. All or a portion of the higher pressure fluid cavity 104 may comprise a buffer air chamber.

The lower pressure fluid cavity 102 may be referred to as a second cavity, and may be, for example, a region of a rotating machine such as a gas turbine engine that receives and directs lower pressure and/or lower temperature airflow. The lower pressure cavity 102 may be a sump or bearing chamber.

The rotatable shaft 106 may define an axis A of the rotating machine. The rotatable shaft may be hollow. A housing 108 may be disposed about or radially outward of the rotatable shaft 106. The housing 108 may be radially displaced from the shaft 106. The housing 108 may be a static structure of the rotating machine (i.e. may not rotate). The housing 108 may be a sump housing or similar structure, and may at least partly define each of the higher pressure fluid cavity 104 and lower pressure fluid cavity 102.

The seal ring 110 is disposed between the housing 108 and the shaft 106. The seal ring 110 may be annular, and may be formed as a single member or may comprise more than one member. In embodiments having a seal ring 110 comprising more than one member, the member may be joined for example by slip joints. The seal ring 110 may also comprise a single annular member. The seal ring 110 may have a radially outward facing surface 114 and a radially inward facing seal surface 116. The seal ring may comprise carbon.

The runner 112 may be an annular member and may be radially displaced from the shaft 106. The runner 112 may be carried by the shaft 106. The runner 112 may be carried by a runner mounting assembly 160 coupled to the shaft 106. The runner 112 may have a radially outward facing seal surface 120 and a radially inward facing mount surface 125 extending axially along the shaft 106. The runner 112 may comprise ceramic. The runner 112 may comprise silicon carbide, silicon nitride, or alumina.

The seal ring 110 may be an archbound carbon seal. The seal ring 110 may sealingly engage the runner 112. A seal ring 110 that is sealingly engaged with a runner 112 is in contact with the runner 112 or in sufficient proximity to the runner 112 such that a seal is formed between the seal ring 110 and runner 112. The radially inward facing surface 116 of the seal ring 110 may sealingly engage the radially outward facing surface 120 of the runner 112. In some embodiments, the radially inward facing surface 116 of the seal ring 110 may contact the radially outward facing surface 120 of the runner 112.

The seal ring 110 and runner 112 may be formed from materials having coefficients of thermal expansion that are matched to effect sealing engagement between the seal ring 110 and runner 112 over a predetermined range of operating temperatures.

The runner mounting assembly 160 may be carried by the shaft 106, and may extend radially from the shaft 106 to space the runner 112 from the shaft 106. The runner mounting assembly 160 may comprise a mounting member 161 having a circumferential base 162 and a pair of spring retainers 163-A, 163-B. The circumferential base 162 may be affixed to the shaft 106, for example by an interference fit. In some embodiments a base mount 170 is positioned intermediate the base 162 and shaft 106.

The pair of spring retainers 163-A, 163-B may extend axially and radially from the base 162. The spring retainers may include a first spring retainer 163-A extending axially forward and radially outward from the base 162 and a second spring retainer 163-B extending axially aft and radially outward from the base 162.

The first spring retainer 163-A and second spring retainer 163-B may be joined by the base 162. The first spring retainer 163-A and second spring retainer 163-B provide a spring action retention of the runner 112 to maintain the runner sealingly engaged with the seal ring 110 during various operating conditions and transients. The first spring retainer 163-A and second spring retainer 163-B may comprise metal, such as steel.

Each of the first spring retainer 163-A and second spring retainer 163-B impart a radially outward spring force and deflect to maintain the runner 112 sealingly engaged with the seal ring 110 as the rotating machine operates. During periods of thermal expansion, or when components are in a thermally expanded state, the first spring retainer 163-A and second spring retainer 163-B deflect to accommodate the thermal expansion of the shaft 106 and/or base 162 relative to the runner 112. This deflection accommodates the shrinking radial dimension of the space between the runner 112 and the shaft 106. The deflecting motion of first spring retainer 163-A and second spring retainer 163-B is shown at Arrows A1 and A2, respectively, in FIG. 2.

The magnitude and rate of stress on the runner 112 during period of thermal expansion are greatly reduced as compared to existing clip-type runner mounts. Even at the high operating temperatures experienced by certain seal assemblies during engine operation, the disclosed runner mounting assembly 160 supports the runner 112 while sufficiently compliant as to not cause excessive stresses on the runner 112. The runner mount assembly 160 is effective to dissipate stress and/or energy through deflection of the spring retainers 163-A, 163-B.

During periods of thermal contraction or when components are in a thermally contracted state, the first spring retainer 163-A and second spring retainer 163-B provide spring action in a radially outward direction to accommodate the thermal contraction of the shaft 106 and/or base 162. This spring action accommodates the increasing radial dimension of the space between the runner 112 and the shaft 106.

One of the first spring retainer 163-A and second spring retainer 163-B may include a radially-extending axial locator 168. The axial locator 168 may interface with a corresponding locator groove 169 defined by the runner 112 to assist with maintaining the axial positioning of the runner 112. For example, in the illustrated embodiment of FIGS. 1 and 2 the first spring retainer 163-A includes an axial locator 168 that interfaces with locator groove 169 to arrest axially-forward motion of the runner 112.

The runner mounting assembly 160 may further comprise a first axial retainer 164-A and a second axial retainer 164-B. The first axial retainer 164-A may comprise a circumferential base portion 165-A and a retaining portion 166-A extending radially outward from the base portion 165-A. The second axial retainer 164-B may comprise a circumferential base portion 165-B and a retaining portion 166-B extending radially outward from the base portion 165-B.

The first axial retainer 164-A and second axial retainer 164-B may be affixed to the shaft 106, for example by interference fit with the shaft 106. The second axial retainer 164-B may be axially displaced from the first axial retainer 164-A. The mounting member 161 may be positioned axially intermediate the first axial retainer 164-A and the second axial retainer 164-B.

The retaining portions 166-A, 166-B of the first axial retainer 164-A and second axial retainer 164-B serve as axial stops that prevent excessive axial motion of the runner 112. The retaining portion 166-A of the first axial retainer 164-A prevents excessive forward axial motion of the runner 112. The retaining portion 166-B of the second axial retainer 164-B prevents excessive aftward axial motion of the runner 112.

The runner mounting assembly 160 carries the runner 112. The runner 112 may be axially positioned between the retaining portions 166-A, 166-B of the first axial retainer 164-A and the second axial retainer 164-B. The runner 112 may be radially positioned between the pair of spring retainers 163-A, 163-B and the seal ring 110, such that the radially inward facing surface 116 of the seal ring 110 sealingly engages the radially outward facing surface 120 of the runner 112 to thereby form a boundary between the higher pressure fluid cavity 104 and the lower pressure fluid cavity 102.

The runner mounting assembly 160 allows for relative movement between the runner 112 and the shaft 106, largely owing to different coefficients of thermal expansion of the materials of the runner 112 and the shaft 106. Due to the runner mounting assembly 160, the runner 112 may flex relative to the shaft 106.

The seal assembly may further comprise an annular seal member 111. The annular seal member 111 is axially displaced from the seal ring 110 and may comprise a flexible and/or semi-rigid material. The annular seal member 111 may be referred to as a lip seal or a lip seal member. The annular seal member 111 may comprise Teflon or a Teflon derivative material. The annular seal member 111 may be an annular flexible ring that is flexed when positioned relative to the runner 112 (i.e. the annular seal member 111 may be flexed by contact with the runner 112). In some embodiments the annular seal member 111 may be formed as a curved member having a J-shaped cross section. The annular seal member 111 may have a curvilinear face surface 131 that engages the radially outward facing seal surface 120 of the runner 112. The curvilinear face surface 131 may extend from an axially-facing surface to a radially-facing surface, and the radially-facing surface engages the radially outward facing seal surface 120 of the runner 112.

The seal ring 110 may define a plurality of apertures 117 that extend axially through the seal ring 110. During operation, with a higher fluid pressure in the higher pressure fluid cavity 104 as compared to the lower pressure fluid cavity 102, the apertures 117 direct a flow of buffer air from the higher pressure fluid cavity 104 toward the annular seal member 111. The plurality of apertures 117 may be dimensioned and/or spaced about the circumference of the seal ring 110 to achieve a desired flow rate of buffer air.

The flow of buffer air flows through the plurality of apertures 117 and contacts the curvilinear face surface 131 of the annular seal member 111. The flow of buffer air buffers the annular seal member 111. The flow of buffer air additionally reduces leakage from the lower pressure fluid cavity 102 toward the higher pressure fluid cavity 104 past the annular seal member 111 and/or the seal ring 110, by blowing back any oil into the lower pressure fluid cavity 102 if a leakage path develops in the seal ring 110 and/or annular seal member 111.

In some embodiments, the seal assembly 100 further comprises a seal housing 122. The seal housing 122 may be disposed between the runner 112 and the housing 108, and/or between the seal ring 110 and the housing 108, and/or between the annular seal member 111 and the housing 108. The seal housing 122 may comprise a forward seal housing 124 and an aft seal housing 126.

The forward seal housing 124 may define a recess 128 or may cooperate with the aft seal housing 126 to define a recess 128. The recess 128 may be an annular groove. At least a portion of the annular seal member 111 may be disposed in or held in axial position by the recess 128. The forward seal housing 124 may be prevented from axially forward movement relative to the housing 108 by a housing stop 134.

The aft seal housing 126 may comprise an axially-extending portion 121 and a radially-extending portion 123. The axially extending portion 121 may be engaged with or in contact with the housing 108. The radially extending portion 123 may comprise an axially facing surface 132 and may be engaged with or in contact with the seal ring 110. The seal ring 110 may sealingly engage the axially facing surface 132 of the radially extending portion 123 of the seal housing 122. The seal ring 110 may be aided in sealingly engaging the axially facing surface 132 by the axial load on the seal ring 110 caused by the pressure difference between the higher pressure cavity 104 and lower pressure cavity 102.

The forward seal housing 124 and aft seal housing 126 may be integrally formed as a single seal housing 122.

In some embodiments, the seal assembly 100 further comprises a garter spring 129. The garter spring 129 may be disposed radially outward of and engaged with a radially outer surface of the seal ring 110. The garter spring 129 may aide with maintaining engagement of the seal ring 110 to the runner 112 across a predetermined range of rotational speeds.

In some embodiments, the seal assembly 100 further comprises one or more of a snap ring 133 and back plate 135. The snap ring 133 may extend between the seal housing 122 and the runner 112, and may be positioned axially aft of the seal ring 110. The back plate 135 may be positioned axially aft of the seal ring 110 and adjacent and/or abutting the snap ring 133.

In a non-operating condition, the shaft 106 is not rotating and the garter spring 129 imparts a radially inward force on the seal ring 110 to maintain the seal ring 110 sealingly engaged against the runner 112. The seal ring 110 sealingly engaged with the runner 112 and seal housing 122 creates a seal between the higher pressure fluid cavity 104 and the lower pressure fluid cavity 102. The seal ring 110 forms a boundary between the higher pressure fluid cavity 104 and the lower pressure fluid cavity 102.

When the rotating machine begins to operate, heat generated by the rotating machine will cause temperatures of all components to rise, including heat generated by friction between the seal ring 110 and runner 112. As the shaft 106 and base 162 thermally expand in a radially outward direction, the spring retainers 163-A, 163-B deflect to accommodate the compression between the runner 112 and the shaft 106 and base 162. The forward spring retainer 163-A deflects axially forward and radially inward (indicated at Arrow A1 on FIG. 2), while the aft spring retainer 163-B deflects axially aft and radially inward (indicated at Arrow A2 on FIG. 2). The radial dimension of FIG. 2 is exaggerated to better illustrate spring retainers 163-A, 163-B. The motion by the spring retainers 163-A, 163-B dissipates energy while maintaining proper engagement between the runner 112 and seal ring 110.

During operation, in embodiments having a seal ring 110 and runner 112 with matched coefficients of thermal expansion, the seal ring 110 and runner 112 will thermally expand at the same or similar rates, assisting in the maintenance of engagement between the seal ring 110 and runner 112 throughout the full range of thermal transients caused by startup and operation of the rotating machine. For embodiments having an annular seal member 111, a differential pressure between the fluid pressures of the higher pressure fluid cavity 104 and the lower pressure fluid cavity 102 may create a flow of buffer air. The flow of buffer air flows through the plurality of apertures 117 of the seal ring 110 and contacts the curvilinear face surface 131 of the annular seal member 111. The flow of buffer air buffers the annular seal member 111. The flow of buffer air additionally reduces leakage from the lower pressure fluid cavity 102 toward the higher pressure fluid cavity 104 past the annular seal member 111 and/or the seal ring 110.

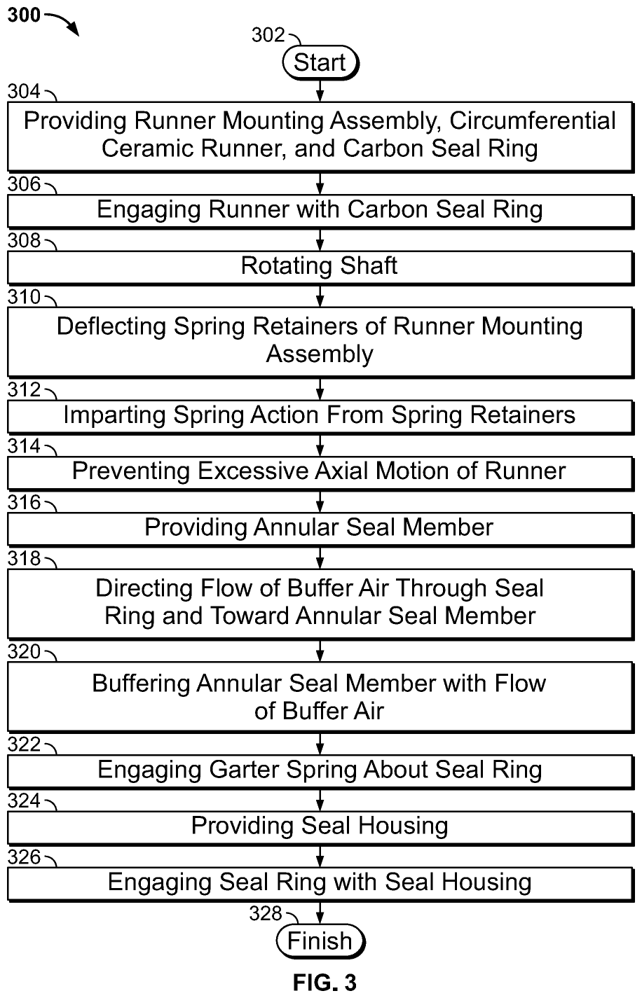

The present disclosure additionally provides methods of sealing a higher pressure fluid cavity 104 from a lower pressure fluid cavity 102. FIG. 3 presents a flow chart of one such method 300. The higher pressure fluid cavity 104 and lower pressure fluid cavity 102 are at least partly disposed between a rotatable shaft 106 and a housing 108 radially displaced from the rotatable shaft 106.

Method 300 starts at Block 302. The steps of method 300, presented at Blocks 302 through 328, may be performed in the order presented in FIG. 3 or in another order. One or more steps of the method 300 may not be performed.

At Block 304, a runner mount assembly 160, runner 112, and seal ring 110 may be provided. The runner mount assembly 160 may comprise a pair of axial retainers 164-A, 164-B and a mounting member 161 positioned intermediate the axial retainers 164-A, 164-B. The mounting member 161 may comprise a base 162 and a pair of spring retainers 163-A, 163-B extending axially and radially from the base 162. The base 162 may be affixed to a shaft 106 of a rotating machine. The spring retainers 163-A, 163-B engage the runner 112 and hold the runner 112 at a radial offset from the shaft 106.

The runner 112 and seal ring 110 may be sealingly engaged at Block 306. At Block 308, the shaft 106 may be rotated. Rotation of the shaft 106 may generate heat in the rotating machine, either through operation of the machine and/or friction between rotating and non-rotating components. This heat generation will cause the shaft 106 and/or base 162 to thermally expand.

At Block 310 the spring retainers 163-A, 163-B deflect to accommodate the thermal expansion of the shaft 106 and/or base 162, while maintaining engagement of the runner 112 and seal ring 110. Thermal expansion of the shaft 106 and/or base 162 reduces the radial dimension separating the runner 112 from the shaft 106 and base 162. The spring retainers 163-A, 163-B deflect axially and radially to accommodate this change in the radial dimension while ensuring continued engagement of the runner 112 and seal ring 110.

At Block 312 the spring retainers 163-A, 163-B may impart spring action to accommodate the thermal contraction of the shaft 106 and/or base 162 resulting from cooling operating temperatures, reduced friction, or machine shut down, while maintaining engagement of the runner 112 and seal ring 110. Thermal contraction of the shaft 106 and/or base 162 increases the radial dimension separating the runner 112 from the shaft 106 and base 162. The spring retainers 163-A, 163-B spring axially and radially to accommodate this change in the radial dimension while ensuring continued engagement of the runner 112 and seal ring 110.

At Block 314 excessive axial motion of the runner 112 is prevented by one or more of the axial retainers 164-A, 164-B of the runner mounting assembly 160. Each axial retainer 164-A, 164-B may comprise a circumferential base portion 165-A, 165-B and a retaining portion 166-A, 166-B that extends radially outward from the circumferential base portion 165-A, 165-B. The retaining portion 166-A, 166-B may constrain excessive axial motion of the runner 112.

At Block 316 an annular seal member 111 may be provided. A flow of buffer air may be directed through one or more apertures 117 in the seal ring 110 at Block 318. The buffer air flow is directed toward the annular seal member 111. At Block 320, the buffer air flow buffers the annular seal member 111.

At Block 322 a garter spring 129 may be engaged about the seal ring 110 and may aid in maintaining the seal ring 110 engaged with the runner 112.

At Block 324 a seal housing 122 may be provided and at Block 326 the seal ring 110 may be engaged with the seal housing 122.

Method 300 ends at Block 328.

The present disclosure provides numerous advantages over existing seal assemblies. For example, the presently disclosed seal assembly 100 and method 300 of forming a seal reduce edge loading and overall stresses experienced in clip-style runner mounts. By mounting the runner from the inner diameter of the runner alone, as opposed to mounting from the inner and outer diameters, the runner/runner mount interface along the outer diameter is eliminated and therefore the edge loading at that interface is also eliminated. The disclosed seal assembly provides improved load distribution and minimized tensile stresses in the runner.

By mounting the runner from the inner diameter alone, the presently disclosed seal assembly also frees space along the outer diameter to have a larger sealing surface. This may enable the inclusion of a lip seal along the sealing surface, owing to the greater size of the sealing surface.

The disclosed seal assembly may be advantageously used in applications where a seal assembly is required in an extremely tight space. For example, the seal assembly may be positioned in applications where the radial gap between the shaft and ceramic runner is less than 0.5 inches. The seal assembly was designed for small space applications while maintaining adequate runner support and manufacturability.

The presently-disclosed seal assembly also includes an advantageous fail-safe. The clearance between the runner 112 and base 162 is controlled such that even in the event of a failure of one or more spring retainers 163-A, 163-B, the runner 112 will remain sealingly engaged with or near the seal ring 110. In other words, the seal formed by the seal ring 110 and runner 112 will remain supported even during failure of a spring retainer 163-A, 163-B because the runner 112 will rest on the base 162. This fail-safe ensures no or minimal leakage past the seal during spring retainer failure, thus reducing the likelihood of oil coking, fires, or similar hazards created by seal leakage. Another advantage of this fail-safe is that any loose material created by the spring retainer failure (i.e. pieces of the failed spring retainer) are contained in the space bounded by the shaft, runner, and axial retainers.

The presently-disclosed seal assembly may also be manufactured less expensively than existing seal assemblies. Manufacturing of the mount member would typically comprise machining of the base 162, creating each of the spring arms from one or more pieces of sheet metal (such as 25 gauge stamped sheet metal), and brazing the spring arms to the base. The mount member may also be manufactured via 3D printing, which would eliminate the brazed interface between the spring retainers and the base.

Although examples are illustrated and described herein, embodiments are nevertheless not limited to the details shown, since various modifications and structural changes may be made therein by those of ordinary skill within the scope and range of equivalents of the claims.

What is claimed is:

1. A seal assembly for sealing a higher pressure fluid cavity from a lower pressure fluid cavity, said cavities at least partially disposed between a rotatable shaft and a housing radially displaced from said rotatable shaft, the seal assembly comprising:
a runner mounting assembly carried by the shaft, said runner mounting assembly comprising:
a first axial retainer affixed to the shaft, said first axial retainer comprising a circumferential base portion and a retaining portion extending radially outward from said base portion;
a second axial retainer affixed to the shaft at a position axially displaced from said first axial retainer, said second axial retainer comprising a circumferential base portion and a retaining portion extending radially outward from said base portion; and
a mounting member positioned axially intermediate said first and second axial retainers, said mounting member comprising a circumferential base affixed to the shaft and a pair of spring retainers extending axially and radially from said base;
a carbon seal ring sealingly engaged with the housing and having a radially inward facing seal surface; and
a circumferential ceramic runner having a radially outward facing seal surface and a radially inward facing mount surface, said runner being axially positioned between the retaining portions of said first and second axial retainers, said runner being radially positioned between said spring retainers and said carbon seal ring so that said radially inward facing seal surface of said carbon seal ring sealingly engages said radially outward facing seal surface of said runner to thereby form a boundary between the higher pressure fluid cavity and the lower pressure fluid cavity.

2. The seal assembly of claim 1 wherein the pair of spring retainers deflect to maintain engagement of the runner and seal ring while accommodating thermal expansion of the shaft.

3. The seal assembly of claim 2 wherein the pair of spring retainers impart spring action to maintain engagement of the runner and seal ring while accommodating thermal contraction of the shaft.

4. The seal assembly of claim 3 wherein said radially outward facing seal surface of said runner is free of loading from the runner mounting assembly.

5. The seal assembly of claim 1 wherein one of the pair of spring retainers comprises an axial locator, and wherein the ceramic runner comprises a locator groove that interfaces with the axial locator to maintain an axial position of the ceramic runner relative to the runner mounting assembly.

6. The seal assembly of claim 1 wherein said pair of spring retainers comprises a first spring retainer extending axially forward and radially outward from the base and a second spring retainer extending axially aft and radially outward from the base.

7. The seal assembly of claim 1 wherein the runner mounting assembly comprises metal.

8. The seal assembly of claim 1 further comprising an annular seal member coupled to the housing axially displaced from said seal ring in the lower pressure fluid cavity, the seal member having a curvilinear face surface that engages said radially outward facing seal surface of said runner.

9. The seal assembly of claim 8 wherein said higher pressure fluid cavity comprises at least in part a buffer air chamber, and wherein a plurality of apertures extending axially through the seal ring direct a flow of buffer air from the buffer air chamber toward the annular seal member.

10. The seal assembly of claim 9 wherein said curvilinear face surface bends from an axially-facing surface to a radially-facing surface, and wherein said radially-facing surface engages said radially outward facing seal surface of said runner.

11. The seal assembly of claim 1 wherein said runner and said seal ring are formed from materials having coefficients of thermal expansion that are matched to effect sealing engagement between said runner and said seal ring over a predetermined range of operating temperatures.

12. The seal assembly of claim 1 further comprising a garter spring coupled to a radially outward facing surface of the seal ring, the garter spring sealingly engaging the radially inward facing seal surface of the seal ring with the radially outward facing seal surface of the ceramic runner across a predetermined range of rotational speeds.

13. A seal assembly for sealing a first fluid cavity from a second fluid cavity in a rotating machine, said cavities at least partially disposed between a rotatable shaft and a housing radially displaced from said rotatable shaft, the seal assembly comprising:
a circumferential ceramic runner having a radially outward facing seal surface and a radially inward facing mount surface extending axially along the shaft;
a runner mounting assembly carried by the shaft and carrying the ceramic runner, the runner mounting assembly comprising:
a base member positioned at a radial offset from the ceramic runner;
a pair of metallic spring retainers, a first spring retainer extending axially forward from the base member and a second spring retainer extending axially aft from the base member, the spring retainers extending across the radial offset and engaging a portion of the radially inward facing mount surface of the runner; and
a carbon seal ring sealingly engaged with the housing and having a radially inward facing seal surface that sealingly engages at least a portion of said radially outward facing seal surface of said runner.

14. The seal assembly of claim 13 wherein the pair of spring retainers deflect to maintain engagement of the runner and seal ring while accommodating thermal expansion of the shaft.

15. The seal assembly of claim 14 wherein the pair of spring retainers impart spring action to maintain engagement of the runner and seal ring while accommodating thermal contraction of the shaft.

16. The seal assembly of claim 13 wherein one of the pair of spring retainers comprises an axial locator, and wherein the ceramic runner comprises a locator groove that interfaces with the axial locator to maintain an axial position of the ceramic runner relative to the runner mounting assembly.

17. A method of sealing a higher pressure fluid cavity from a lower pressure fluid cavity, said cavities at least partially disposed between a rotatable shaft and a housing radially displaced from said rotatable shaft, the method comprising:
providing a runner mounting assembly, a circumferential ceramic runner, and a carbon seal ring, wherein the runner mounting assembly is carried by the shaft and carries the ceramic runner, the runner mounting assembly comprising a pair of spring retainers extending axially and radially from a base member to engage a portion of the runner;
engaging the runner with the carbon seal ring;
rotating the shaft; and
deflecting the pair of spring retainers responsive to thermal transients to alter the radial position of the runner relative to the shaft.

18. The method of claim 17 further comprising imparting spring action from the spring retainers responsive to thermal transients to alter the radial position of the runner relative to the shaft.

19. The method of claim 17 further comprising preventing excessive axial motion of the ceramic runner with one or more axial retainers.

20. The method of claim 17 further comprising:
providing an annular seal member axially displaced from the carbon seal ring, the carbon seal ring defining a plurality of apertures passing axially through the seal ring;
directing a flow of buffer air through one or more of the plurality of apertures and toward the annular seal member; and
buffering the annular seal member with the flow of buffer air.
